(19) United States
(12) Patent Application Publication
(10) Pub. No.: US 2006/0176882 A1
(43) Pub. Date: Aug. 10, 2006

(54) Method and system of early indication for multi-user wireless communication systems

(75) Inventors: Brett Eric Schein, San Jose, CA (US); Trevor Pearman, Sunnyvale, CA (US)

Correspondence Address: Breh Schein, Suite 101, 3930 Freedom Circle, Santa Clara, CA, 95054, US

(73) Assignee: Beceem Communications Inc.

(21) Appl. No.: 11/056,311

(22) Filed: Feb. 10, 2005

(51) Int. Cl. H04L 12/28

(52) U.S. Cl. 370/395.32

(57) ABSTRACT

The present invention relates to a method of providing an early indication of at least one burst allocation made for at least one subscriber station by allocating a predetermined number of bits representing the early indication. The invention also provides a method for generating the predetermined number of bits for providing the early indication by determining whether the subscriber station has the allocation in a current frame and setting a related bit in the predetermined numbers of bits to a predetermined value when an allocation is made for the subscriber station.

### FIELD OF INVENTION

The present invention relates to method of providing an early indication of an allocation made for a subscriber station in a multi-user wireless communication system.

### BACKGROUND OF THE INVENTION

In a typical multi-user wireless communication system, multiple subscriber stations (SS) access resources using a centralized approach where a base station (BS) manages the access and resource allocations for the SS. There are two links of transmission between the BS and the SS based on the direction of transmission. An uplink carries data from the SS to BS, while a downlink delivers data from the BS to the SS. The data is transmitted in the form of frames that include a preamble, control information and at least one data burst. The data burst contains a resource, such as a web page, that is being accessed by the SS. The control information includes an Uplink Map (UL-MAP) that is used to indicate a burst allocation for the SS in the uplink, and a Downlink Map (DL-MAP) that is used to indicate an allocation of each SS in the downlink. The two links have different frame structures. In case of a downlink, the frame contains the data bursts sent to SS and the control information for both links (uplink as well as downlink).

The DL-MAP or the UL-MAP includes the burst allocation, for each SS or connections on the SS that are associated with the data bursts. The burst allocation contains several pieces of information that include a connection ID (CID) or subscriber station ID (SSID), physical resources used for the burst (i.e. information such as starting logical frequency, starting timeslot, ending logical frequency and timeslot), and a communication mode used for the burst (i.e. information such as modulation order, code, code rate, an indicator for space-time code). Therefore, if there were 20 bursts newly allocated in a frame, each burst would contain a corresponding burst allocation and the DL-MAP for the frame would have 20 burst allocations. In a typical wireless communication, the SS must either scan through the entire DL-MAP, or for downlink transmissions, potentially decode each burst allocation in order to determine whether the BS has made an allocation for one of its connections. Considering that the SS is a device with limited resources, the processing of the entire DL-MAP by the SS is a relatively inefficient method that consumes additional power at the SS.

A need is therefore felt to provide an indication of an allocation made for the SS in such a way that the SS would not need to process the entire DL-MAP.

### BRIEF DESCRIPTION OF THE DRAWINGS

The accompanying figures together with the detailed description below are incorporated in and form part of the specification, serve to further illustrate various embodiments and to explain various principles and advantages all in accordance with the present invention, and should not be construed to limit the invention.

FIG. 1 shows an exemplary configuration of a wireless communication system in accordance with a first embodiment.

FIG. 2 is a flow diagram depicting the steps of the working of an early indication method.

FIG. 3 is a block diagram depicting a map structure.

FIG. 4 is a flow diagram depicting the steps for generating a predetermined number of bits.

### DETAILED DESCRIPTION

The present invention may be embodied in several forms and manners. The description provided below and the drawings show exemplary embodiments of the invention. Those of skill in the art will appreciate that the invention may be embodied in other forms and manners not shown below. The invention shall have the full scope of the claims and is not to be limited by the embodiments shown below.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of the claims as issued.

It is further understood that the use of relational term, if any, such as first and second, top and bottom, and the like are used solely for distinguishing one from another entity or action without necessarily requiring or implying any actual such relationship or order between such entities or actions. Much of the inventive functionality and many of the inventive principles are best implemented at the network level with or in software instructions and related hardware. It is expected that one of ordinary skill, notwithstanding possibly significant effort and many design choices motivated by, for example, available time, current technology and economic considerations, when guided by the concepts and principles disclosed herein will be readily capable of generating such software instructions and hardware with minimal experimentation. Therefore, in the interest of brevity and minimization of any risk of obscuring the principles and concepts according to the present invention, further discussion of such software and hardware, if any, will be limited to the essentials with respect to the principles and concepts within the preferred embodiments.

An embodiment of the invention comprises a multi-user wireless transmission method where a field is included in an allocation map contained in a broadcast made by at least one base station (BS) to at least one subscriber station (SS). The BS sends the allocation map to all subscriber stations whenever a burst allocation is made. In conventional systems, the SS would need to scan the entire allocation map to determine whether the allocation map contains an allocation for the SS. However, adding a field to the allocation map helps reduce the amount of processing required at the SS. The field includes a predetermined number of bits. In a typical wireless communication system, the allocation map comprises a plurality of burst allocations. The burst allocations comprise a connection ID (CID) or a subscriber station ID (SSID) of a plurality of subscriber stations, information on the physical resources used for the burst (starting logical frequency, starting timeslot, ending logical frequency and/or timeslot), communication modes used for the burst (modulation order, code, code rate, space-time code) and the like. The field including a predetermined number of bits provides simultaneous information about the CID or SSID of the subscriber stations for which the allocations have been made in the frame.

A hash function assigns every subscriber station to a bit in the predetermined number of bits in the field. When the bit is set to 1, it indicates that a burst may have been made for the corresponding SS. This avoids decoding the entire allocation map every time for the burst made for the subscriber station. This method also saves a considerable amount of power since the need to browse through the entire map every time a burst allocation is made is eliminated.

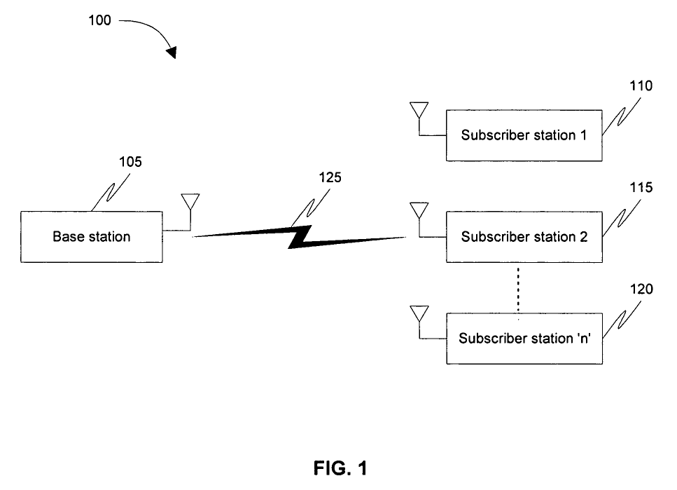

FIG. 1 depicts an exemplary diagram 100 of a multi-user wireless communication system. At least one base station (BS) 105 transmits a plurality of bursts through a wireless channel 125 to at least one subscriber station (SS) 110, 115, 120. The SS 110, 115, 120 can be a laptop, a computer, a mobile phone and a personal digital assistant (PDA).

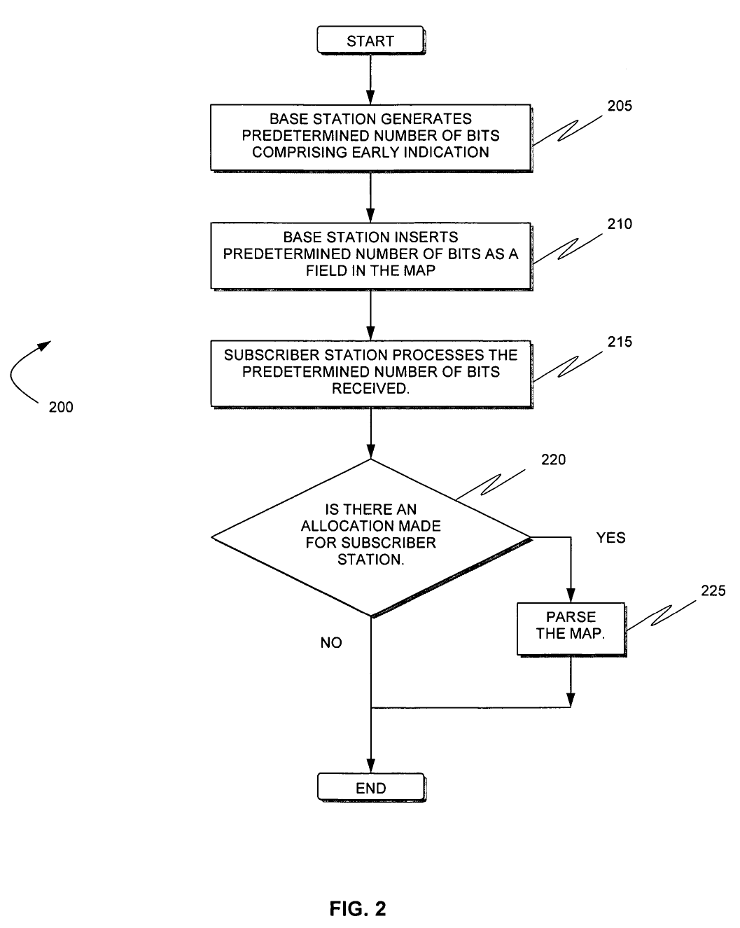

FIG. 2 is a flow chart 200 depicting the working of an early indication method. Typically at least one BS indicates an allocation made for at least one SS through an allocation map sent as a part of a frame used for communication between the BS and the SS. The BS indicates the early indication by adding a field to the allocation map. The field comprises a predetermined number of bits.

As depicted in step 205, the BS generates the field by using a first mathematical function. In one embodiment of the invention, the first mathematical function could be a hash function. The first mathematical function takes a Subscriber ID (SSID) or a Connection ID (CID) as an input and generates an integer in the range of zero to the predetermined number of bits minus one. For every allocation made in the frame, the BS sets the bit associated with the SSID or CID in the field based on the integer generated. Each SSID or CID is assigned a single bit position in the field. Further, a particular bit position may be assigned to a plurality of SS's.

The predetermined number of bits is determined by using a second mathematical function. In an embodiment of the invention, the second mathematical function could be a probability-based function.

After generating the field, as depicted in step 210, the BS inserts the field as a part of the map sent to the SS. Rather than using a single map to indicate all the allocations of all the bursts in the frame, the BS may use a series of maps such that each map indicates a subset of all the allocations of all the bursts in a same frame; for example: a first map may allocate 6 new bursts, a second map may allocate another 5 new bursts, and a third MAP may allocate another 9 new bursts. In one embodiment of the invention, the field is included in a first map, where the predetermined number of bits is set using all of the SSIDs or CIDs associated with all the bursts in all of the maps. In another embodiment of the invention, the field includes a plurality of sub-fields, each sub-field in each map, and the bits of the sub-field in a particular map are set using only those SSIDs or CIDs associated with bursts in that particular map.

As shown in step 215, the SS receives the map and processes the field before parsing the map. Based on the processing of the field, the SS would check, step 220, whether an allocation may have been made for one of its connections in the current frame. If the bit in the field indicates an allocation that may have been made for the SSID or CID, step 225, the SS would further parse the map to obtain the burst made for the SS, else it would not process the map any further.

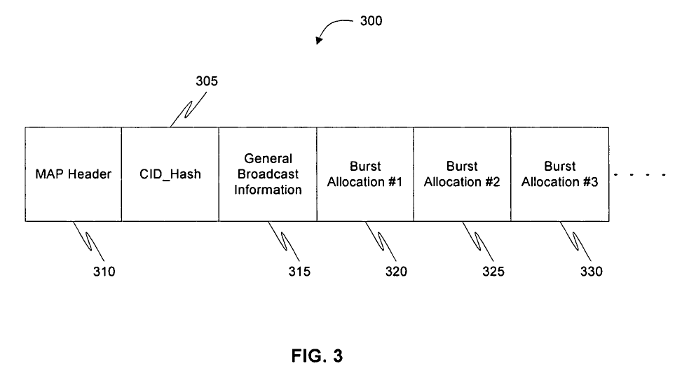

FIG. 3 is a block diagram 300 depicting a structure of an allocation map. In a typical wireless system, the allocation map includes a map header 310 and general broadcast information 315. Further, the map also includes at least one burst allocation information (320, 325, 330) that includes the CID or the SSID of the SS for which an allocation has been made in the frame. In a preferred embodiment of the invention, the field 305 denoting the early indication is placed before the burst allocation information (320, 325, 330) to facilitate early detection and processing.

In a typical wireless communication system, each of the burst allocation 320, 325, 330 contains several pieces of information that include a connection ID (CID) or subscriber station ID (SSID), physical resources used for the burst (i.e. information such as starting logical frequency, starting timeslot, ending logical frequency and timeslot), and a communication mode used for the burst (i.e. information such as modulation order, code, code rate, an indicator for space-time code). The predetermined number of bits forms a field 305. The addition of the field 305 helps reduce the processing at the SS.

In an embodiment exemplifying the invention, where there is a plurality of SS connected to the BS, there would a plurality of burst allocation fields present in the map. In a typical wireless communication system, the SS would scan through all the burst allocations in order to determine whether the allocation is made for the SS. However, as depicted in the embodiment 300 of the invention, the field included in the map would have a single bit for each SS (referred to as a related bit) and therefore would have a field of fewer bits to represent all the burst allocations. Those skilled in the art shall appreciate that other ways of associating SS to the predetermined number of bits are also possible, and these ways are within the scope of the present invention.

The SS uses the field to determine whether an allocation has been made for the SS in the frame. The field shall dictate the need for the SS to scan through the burst allocations. Only if the field denotes (by setting a bit in the predetermined number of bits corresponding to the SS for which an allocation has been made) that an allocation may have been made for the SS, the SS will process all the burst allocations further. On receipt of the map, the SS would initially process the field, which in a compact form denotes all the SS that have an allocation made in the frame. Only if the result of such initial processing denotes an allocation for the SS, will the SS scan all the burst allocations further. In an embodiment of the invention, the initial processing could comprise an AND operation to determine whether the allocation has been made for the SS. Using the AND operation, the SS would mask the bits of the field other than the bit corresponding to the SS. The SS would then check whether the result of the AND operation is non-zero. A non-zero result would denote that the SS has an allocation made for it in the frame and therefore it needs to process the map further. On the other hand, if the result of the AND operation is all zeros, the SS would not process the map any further, thereby reducing the processing required and saving power at the SS. The overheads involved in processing of a compact field comprising of the predetermined number of bits is insignificant in comparison to the benefit achieved by saving the processing of all the burst allocations in the map. The technique of using the predetermined number of bits in the field has lesser overheads in processing as compared to a technique of explicitly listing all the CIDs or SSIDs at the beginning of the map. Furthermore, a downlink burst may not have the CID listed in the map. In such a case, an SS is required to decode an allocated burst and check a data payload to see if the data payload is for one of its connections. In this case, the technique is even more useful for saving power.

A SS Medium Access Layer (MAC) typically has to parse the entire map in order to determine whether it has any allocation in the current frame. The present invention enables a SS PHY (Physical Layer) hardware to scan the map partially. Therefore, in an embodiment of the invention, the power used by the SS could considerable saved by having the SS PHY hardware determine directly of an allocation made for the SS in the frame. The need to parse through the entire map or the need to send additional maps to the SS MAC is eliminated.

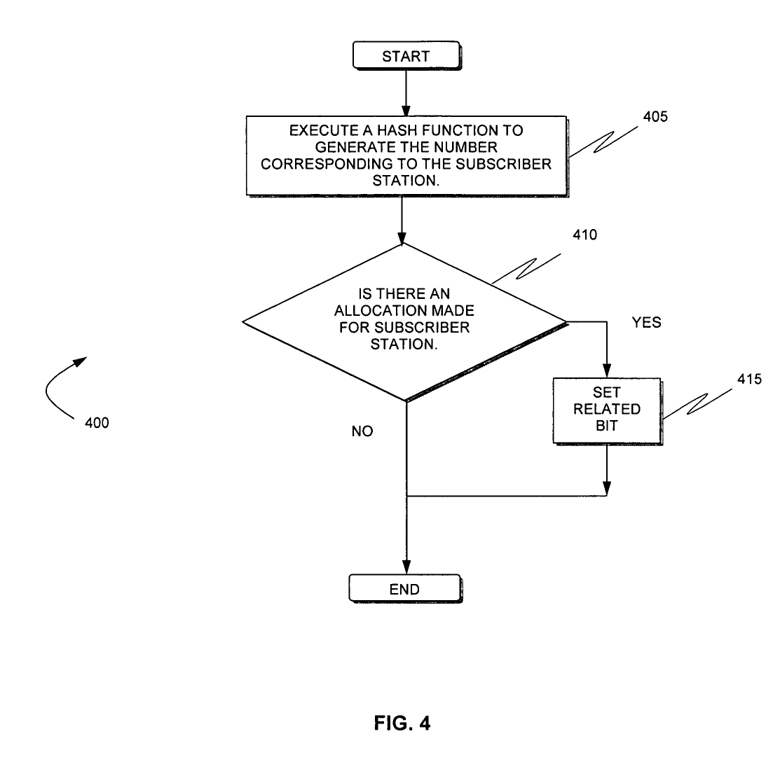

FIG. 4 is a flow chart 400 depicting an embodiment of the invention for creating a hash function to associate each SS to a bit in the predetermined number of bits. In one embodiment, each SS may not be associated with a unique bit in the predetermined number of bits. For example, a 20-bit field can provide a unique identification for any subset of 20 SS's that have an allocation in a frame. In such a case, each SS can be identified with a unique bit position. If there are more than 20 SS's, a bit position in the field may be associated with more than one SS. Therefore if the 20-bit field identifies allocations for 40 SS's, then each bit may be associated with 2 different SS's. The number of bits in the field can be predetermined based on an estimation of the number of SS that may be associated with the BS. In one embodiment, the number of bits can be Nhash. Further, the predetermined number of bits comprise of a related bit corresponding to the each of the SSID or CID.

As depicted in step 405 the BS executes a hash function that takes an identification corresponding to the subscriber station as input. In one embodiment of the invention this input could be a 16-bit basic CID of the SS. The output of the hash function is an integer in the range of zero to the Nₕₐₛₕ minus one. As depicted in step 410, if an allocation is made for the SS in the current frame, the BS sets the bit at the position denoted by the integer in step 415 to one. This is an indication to the SS when it processes the early indication field that there is an allocation made for the SS in the current frame and therefore it needs to parse the allocation map further. In a preferred embodiment of the invention, the hash function could comprise a modulus function. The advantage of using a modulus function is that it is easy to implement and can be easily parameterized by Nₕₐₛₕ (in case Nₕₐₛₕ is changed. Additionally, if we allocate successive basic CID's to successive SS's (one basic CID per SS), then for every possible number of SS's supported by a BS, the hash function using a modulus spreads the hash value assignments most uniformly among the SS's.

Further, Nₕₐₛₕ, which is the number of bits in the field, is determined by using a mathematical function. In a preferred embodiment of the invention the mathematical function could be based on a probability of false indication. For example, the size of the hash function output, for an ideal hash function, fₕₐₛₕ and basic CID's chosen randomly from the plurality of available basic CID assigned to SS's can be determined by constraining a probability of false detection. An ideal hash can be defined as a function for two randomly chosen basic CID's, BCID₁ and BCID₂, such that fₕₐₛₕ(BCID₁)=fₕₐₛₕ(BCID₂) equals 1/Nₕₐₛₕ. The probability of false detection is the probability that an SS has its related bit set to 1, in spite of not having an allocation made for it in the frame.

If there are a total of B bursts allocated in the frame, randomly assigned to SS's (i.e., assume independence between downlink and uplink assignments in a frame). Then assuming an ideal hash function, the probability of false detection equals

$${P}_{FD} = 1 - {( 1 - \frac{1}{{N}_{hash}} )}^{B} . \qquad ( 1 )$$

We rearrange this to make our task easier:

$${N}_{hash} = \frac{1}{1 - {( 1 - {P}_{FD} )}^{\frac{1}{B}}} = \frac{1}{1 - {ⅇ}^{\frac{ln ( 1 - {P}_{FD} )}{b}}} . \qquad ( 2 )$$

Therefore if there are B=20 bursts in the frame, and to achieve P_{FD}≦0.10, the equation above yields the requirement Nₕₐₛₕ≧191. In this case we could make the field 24 bytes. Likewise, B=20 and P_{FD}≦0.20 would require Nₕₐₛₕ≧91, or a 12 byte field.

This method of early indication avoids wastage of resources and saves power. It enables SS to identify allocation bursts made for it without parsing the entire allocation map.

What is claimed is:

1. A method of providing an early indication of at least one allocation made for at least one subscriber station, the method comprising:
allocating a predetermined number of bits wherein the predetermined number of bits represent the early indication; and
indicating the subscriber station using the predetermined number of bits.

2. The allocating method of claim 1, wherein the predetermined number of bits is a field in an allocation map.

3. The allocating method of claim 2, wherein the field is a part of a first allocation map, the first allocation map forming a first of a plurality of allocation maps, the plurality of allocation maps representing a frame.

4. The allocating method of claim 2, wherein the field comprises a plurality of sub-fields; the plurality of sub-fields are a part of a plurality of allocation maps, the plurality of allocation maps representing a frame.

5. The method of claim 1, wherein the indicating step further comprises associating at least one connection on the subscriber station with at least one bit in the predetermined number of bits.

6. The method of claim 5, wherein the associating step further comprises setting the bit associated with the connection when an allocation is made for the connection on the subscriber station.

7. The method of claim 6, wherein the setting of the bit associated with the connection uses a first mathematical function.

8. The method of claim 7, wherein the first mathematical function can be a hash function.

9. The method of claim 8, wherein the predetermined number of bits is determined by a second mathematical function.

10. The method of claim 9, wherein the second mathematical function can be a probability-based function.

11. A method for generating a predetermined number of bits for providing an early indication of at least one allocation made for at least one subscriber station, the method comprising:
determining whether the subscriber station has the allocation in a current frame; and
setting a related bit in the predetermined numbers of bits, the related bit corresponding to the subscriber station.

12. The method of claim 11, wherein the predetermined number of bits is determined using a mathematical function based on a probability of false indication.

13. The method of claim 12, wherein the setting step further comprises
providing an identification corresponding to the subscriber station as an input to a hash function;
executing the hash function; generating an integer between zero to the particular size minus one, the integer corresponding to the related bit in the predetermined numbers of bits.

14. The method of claim 13, wherein the related bit corresponding to the integer is set to one to indicate the allocation made in the current frame for the subscriber station.

15. The method of claim 13, wherein the hash function can be a modulus function.

16. A system of providing an early indication of at least one allocation, the system comprising:
a base station;
at least one subscriber station, the subscriber station receiving an allocation map sent by the base station, the allocation map comprising a predetermined number of bits representing the early indication;
a processor on the subscriber station configured to parse the predetermined number of bits to indicate an allocation made for the subscriber station.

17. The system of claim 16, wherein the subscriber station can comprise a laptop, a personal digital assistant or a mobile phone.

18. The system of claim 16, wherein the predetermined number of bits is a field in an allocation map.

19. The system of claim 18, wherein the field is a part of a first allocation map, the first allocation map forming a first of a plurality of allocation maps, the plurality of allocation maps representing a frame.

20. The system of claim 18, wherein the field comprises a plurality of sub-fields, the plurality of sub-fields being a part of a plurality of allocation maps, the plurality of allocation maps representing a frame.

21. The system of claim 16, wherein at least one connection on the subscriber station corresponds to at least one bit in the predetermined number of bits.

22. The system of claim 21, wherein the bit associated with the connection is set to a predetermined value when an allocation is made for the connection on the subscriber station.

23. The system of claim 22, wherein the bit is associated with the connection on the subscriber station using a first mathematical function.

24. The system of claim 23, wherein the first mathematical function can be a hash function.

25. The system of claim 24, wherein the predetermined number of bits is determined using a second mathematical function.

26. The method of claim 25, wherein the second mathematical function can be a probability-based function.
